(19) United States
(12) Patent Application Publication
(10) Pub. No.: US 2023/0251680 A1
(43) Pub. Date: Aug. 10, 2023

(54) VOLTAGE REGULATION INTEGRATED CIRCUIT

(71) Applicant: REALTEK SEMICONDUCTOR CORP., Hsinchu (TW)

(72) Inventors: Wei-Jyun WANG, Hsinchu (TW); Kai-Yin LIU, Hsinchu (TW); Kai-Yue LIN, Hsinchu (TW)

(73) Assignee: REALTEK SEMICONDUCTOR CORP., Hsinchu (TW)

(21) Appl. No.: 18/106,239

(22) Filed: Feb. 6, 2023

(30) Foreign Application Priority Data
Feb. 9, 2022 (TW) 111104818

(51) Int. Cl. G05F 1/575; G05F 1/46; G05F 3/26; G05F 3/20

(52) U.S. Cl. CPC G05F 1/575; G05F 1/467; G05F 3/205; G05F 3/262

(57) ABSTRACT

A voltage regulation integrated circuit (IC) includes a first transistor, a feedback circuit, a bias circuit, an amplifier circuit, and a transient coupling circuit. The first transistor is configured to generate an output voltage according to an input voltage and a control voltage. The feedback circuit is configured to generate a feedback voltage according to the output voltage. The output voltage includes an AC component. The bias circuit is configured to generate a first bias voltage. The amplifier circuit is configured to generate the control voltage according to the first bias voltage and the feedback voltage. The transient coupling circuit is configured to generate a coupling voltage according to the AC component and to assist the change of the first bias voltage according to the coupling voltage, so that the output voltage is maintained at a voltage level.

### CROSS-REFERENCE TO RELATED APPLICATION

This non-provisional application claims priority under 35 U.S.C. § 119(a) to Patent Application No. 111104818 filed in Taiwan, R.O.C. on Feb. 9, 2022, the entire contents of which are hereby incorporated by reference.

### BACKGROUND

### Technical Field

The instant disclosure relates to a voltage generation technology, especially a voltage regulation integrated circuit (IC).

### Related Art

Generally, a voltage regulator (such as a low-dropout regulator, LDO) is configured to keep an output voltage from being affected by a load. The voltage regulator includes OPAs (operational amplifiers) and power transistors. The voltage regulator utilizes the OPAs and the power amplifiers to prevent the output voltage from changing due to load. However, if the load changes quickly (for example, the load increases or decreases within microsecond range, hereinafter the fast load changes), the OPAs may not be able to correct the output voltage in time. In this case, the output voltage may still be affected by the load, the OPAs need more time to complete the transient response to correct the output voltage, and the power consumption of the OPAs are increased.

### SUMMARY

In view of this, this instant disclosure provides a voltage regulation integrated circuit (IC). According to some exemplary embodiments, the output voltage being affected by the load is avoided while the fast load changes. According to some exemplary embodiments, the transient response can be improved without increasing power consumption.

According to some exemplary embodiments, the voltage regulation integrated circuit includes a first transistor, a feedback circuit, a bias circuit, an amplifier circuit, and a transient coupling circuit. The first transistor is configured to generate an output voltage according to an input voltage and a control voltage. The feedback circuit is configured to generate a feedback voltage according to the output voltage. The output voltage may include an AC component. The bias circuit is configured to generate a first bias voltage. The amplifier circuit is configured to generate the control voltage according to the first bias voltage and the feedback voltage. The transient coupling circuit is configured to generate a coupling voltage according to the AC component and to assist the change of the first bias voltage according to the coupling voltage, so that the output voltage is maintained at a voltage level.

In summary, according to some exemplary embodiments, through the transient coupling circuit, the transient response of the voltage regulation circuit can be hastened while the fast load changes. According to some exemplary embodiments, the transient coupling circuit may be constructed using simple passive elements. Therefore, the transient response of the voltage regulation circuit during fast load changes can be improved without increasing power consumption.

### BRIEF DESCRIPTION OF THE DRAWINGS

The disclosure will become more fully understood from the detailed description given herein below for illustration only, and thus not limitative of the disclosure, wherein:

FIG. 1 illustrates a block diagram of a voltage regulation integrated circuit (IC) according to some exemplary embodiments of the instant disclosure;

FIG. 2 illustrates a block diagram of a voltage regulation integrated circuit according to some exemplary embodiments of the instant disclosure;

FIG. 3 illustrates an impedance frequency response diagram of a first capacitor of a transient coupling circuit according to a first exemplary embodiment of the instant disclosure;

FIG. 4 illustrates a schematic diagram of a transient coupling circuit according to some exemplary embodiments of the instant disclosure;

FIG. 5 illustrates an impedance frequency response diagram of a series circuit of a transient coupling circuit according to a second exemplary embodiment of the instant disclosure;

FIG. 6 illustrates a schematic diagram of a transient coupling circuit according to some exemplary embodiments of the instant disclosure;

FIG. 7 illustrates an impedance frequency response diagram of a series-shunt circuit of a transient coupling circuit according to a third exemplary embodiment of the instant disclosure; and

FIG. 8 illustrates a block diagram of a voltage regulation integrated circuit according to some exemplary embodiments of the instant disclosure.

### DETAILED DESCRIPTION

In this instant disclosure, terms such as “first” and “second” are used to differentiate the elements from one another and not used to sequence the elements or limit the differences among the elements. As a result, the abovementioned terms are not meant to limit the scope of the disclosure. In the disclosure, the transistors may be BJTs (bipolar junction transistors), MOSFETs (metal-oxide-semiconductor field-effect transistors), or other specific transistors. In order to keep the disclosure brief, as an example for description, the transistors are represented by the MOSFETs.

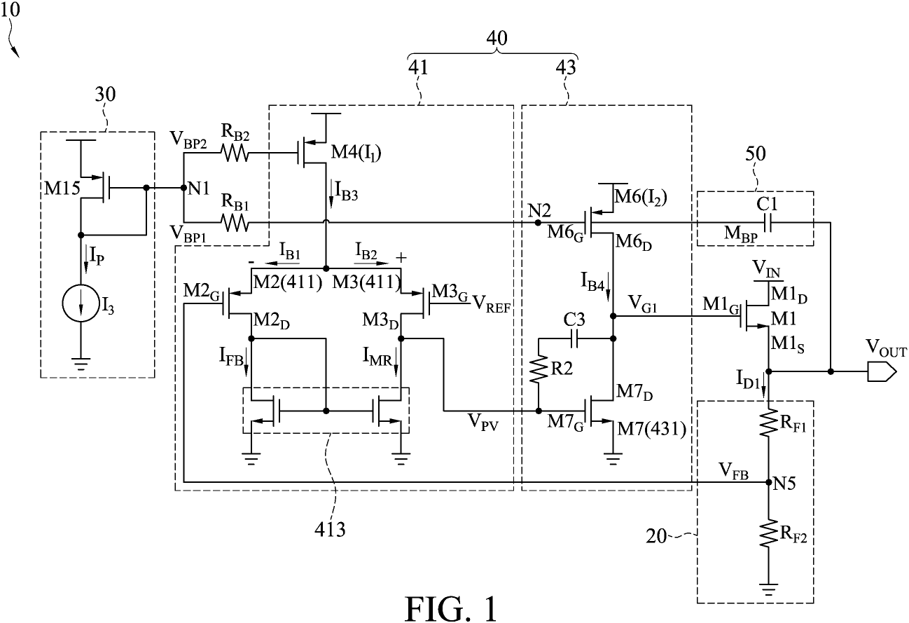

FIG. 1 illustrates a block diagram of a voltage regulation integrated circuit (IC) 10 according to some exemplary embodiments of the instant disclosure. Please refer to FIG. 1. The voltage regulation integrated circuit 10 comprises a first transistor M1, a feedback circuit 20, a bias circuit 30, an amplifier circuit 40, and a transient coupling circuit 50. The amplifier circuit 40 is electrically connected to the first transistor M1. The feedback circuit 20 is electrically connected to the first transistor M1 and the amplifier circuit 40. The bias circuit 30 is electrically connected to the amplifier circuit 40. The transient coupling circuit 50 is electrically connected to the first transistor M1, the amplifier circuit 40, and the feedback circuit 20.

The first transistor M1 is configured to generate an output voltage V_{OUT} according to an input voltage V_{IN} and a control voltage V_{G1}. The output voltage V_{OUT} may be regulated around some preset DC voltage level and it may comprise an AC component according to the output load situation. As an example, the first transistor M1 is an N-channel transistor. A first control end M1_{G} of the first transistor M1 is configured to receive the control voltage V_{G1}, and a first input end M_{1D} of the first transistor M1 is configured to receive an input voltage V_{IN} from outside of the voltage regulation integrated circuit 10. The first transistor M1 is configured to generate the output voltage V_{OUT} at the first output end M1_{S} of the first transistor M1 according to the input voltage V_{IN} and the control voltage V_{G1} so as to provide the output voltage V_{OUT} to circuits outside of the voltage regulation integrated circuit 10. In these embodiments, the first control end M1_{G}, the first input end M1_{D}, and the first output end M1_{S} may respectively be the gate, the drain, and the source of the first transistor M1. In some exemplary embodiments, the first transistor M1 may be a power transistor.

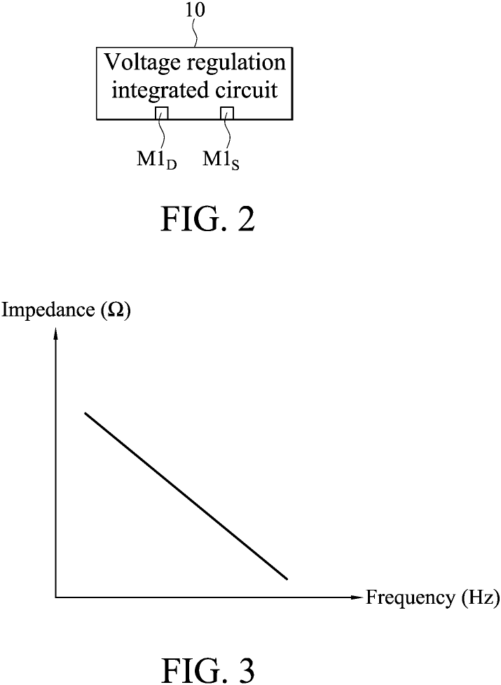

FIG. 2 illustrates a block diagram of the voltage regulation integrated circuit 10 according to some exemplary embodiments of the instant disclosure. Please refer to FIGS. 1 and 2. In some exemplary embodiments, the voltage regulation integrated circuit 10 may be implemented using a chip. The first transistor M1, the feedback circuit 20, the bias circuit 30, the amplifier circuit 40, and the transient coupling circuit 50 are inside the chip, and the first input end M1_{D} and the first output end M1_{S} are the input pin and output pin of the chip, respectively.

In some other exemplary embodiments, the voltage regulation integrated circuit 10 may be a circuitry block of a large scale integrated circuit (or a large scale chip). In yet some other exemplary embodiments, the voltage regulation integrated circuit 10 may be implemented using a plurality of circuitry blocks which are electrically connected with each other. For example, the voltage regulation integrated circuit 10 may be implemented using a first circuitry block, a second circuitry block, a third circuitry block, and a fourth circuitry block. Specifically, in these embodiments, the first circuitry block is the first transistor M1, the second circuitry block is the transient coupling circuit 50,the third circuitry block is the feedback circuit 20, and the fourth circuitry block may be the integration of the circuitry of the voltage regulation integrated circuit 10 except the first circuitry block, the second circuitry block, and the third circuitry block. For example, the bias circuit 30 and the amplifier circuit 40 may be integrated into a single circuitry block as the fourth circuitry block. In some exemplary embodiments, the fourth circuitry block may be an OPA (operational amplifier).

Please refer back to FIG. 1. The feedback circuit 20 is configured to generate a feedback voltage V_{FB} according to the output voltage V_{OUT}. Specifically, in this embodiment, the feedback circuit 20 receives the output voltage V_{OUT} from the first output end M1_{S} of the first transistor M1, generates the feedback voltage V_{FB} according to the output voltage V_{OUT}, and outputs the feedback voltage V_{FB} to the amplifier circuit 40. The feedback voltage V_{FB} changes in response to the change of the output voltage V_{OUT}. For example, when the output voltage V_{OUT} decreases because the load increases (such as when a load current extracted by the voltage regulator integrated circuit 10 at the first output end M1_{S} increases), the feedback voltage V_{FB} decreases; when the output voltage V_{OUT} increases because the load decreases (such as when the load current extracted by the voltage regulator integrated circuit 10 at the first output end M1_{S} decreases), the feedback voltage V_{FB} increases.

The bias circuit 30 is configured to generate a first bias voltage V_{BP1} so as to enable transistors in the amplifier circuit 40. The amplifier circuit 40 is configured to generate the control voltage V_{G1} according to the first bias voltage V_{BP1} and the feedback voltage V_{FB} and to output the control voltage V_{G1} to the first control end M1_{G} of the first transistor M1. The control voltage V_{G1} changes in response to the change of the feedback voltage V_{FB}. For example, when the feedback voltage V_{FB} decreases, the control voltage V_{G1} increases; when the feedback voltage V_{FB} increases, the control voltage V_{G1} decreases. As a result, the output voltage V_{OUT} can be compensated and thus maintained at a voltage level. For example, when the output voltage V_{OUT} decreases because the load increases, the control voltage V_{G1} increases in response to the feedback voltage V_{FB}, and the first transistor M1 increases the output current I_{D1} generated at the first output end M1_{S} in response to the increase of the control voltage V_{G1}, so that the output voltage V_{OUT} increases in response to the increase of the output current I_{D1} and is thus maintained at a voltage level. On the other hand, when the output voltage V_{OUT} increases because the load decreases, the control voltage V_{G1} decreases in response to the feedback voltage V_{FB}, and the first transistor M1 decreases the output current I_{D1} generated at the first output end M1_{S} in response to the decrease of the control voltage V_{G1}, so that the output voltage V_{OUT} decreases in response to the decrease of the output current I_{D1} and is thus maintained at a voltage level. In some exemplary embodiments, the bias circuit 30 and the amplifier circuit 40 may be integrated to be a single OPA.

The transient coupling circuit 50 is configured to generate a coupling voltage M_{BP} according to the AC component of the output voltage V_{OUT}, and the voltage of the sixth control end M6_{G} of the sixth transistor M6 is changed because of the coupling voltage M_{BP}. The change of current of the sixth transistor M6 can be used to adjust the control voltage V_{G1}, so that the output voltage V_{OUT} can be corrected back to the target voltage level even more quickly. For example, when the output voltage V_{OUT} decreases because the load increases, the coupling voltage M_{BP} decreases, and the voltage at the sixth control end M6_{G} of the sixth transistor M6 is decreased because of the decreased coupling voltage M_{BP}, so that an output current of the sixth transistor M6 is increased, raising the control voltage V_{G1}. On the other hand, when the output voltage V_{OUT} increases because the load decreases, the coupling voltage M_{BP} increases, and the voltage at the sixth control end M6_{G} of the sixth transistor M6 is increased because of the increased coupling voltage M_{BP}, so that the output current of the sixth transistor M6 is decreased, lowering the control voltage V_{G1}. As a result, the control voltage V_{G1} can be compensated not only by the amplifier circuit 40 in response to the change of the feedback voltage V_{FB} but also by the transient coupling circuit 50 through controlling the current of the sixth transistor M6. Consequently, the output voltage V_{OUT} can be even more quickly corrected when there is transient change in the load.

In some exemplary embodiments, the transient coupling circuit 50 extracts the AC component of the output voltage V_{OUT} within a frequency band as the coupling voltage M_{BP}. In these embodiments, the transient coupling circuit 50 determines a range of the frequency band according to the relationship between an impedance and a frequency of the coupling circuit 50. As a result, the transient coupling circuit 50 can hasten the effect of the transient response of the amplifier circuit 40 without affecting the DC operation of the voltage regulation integrated circuit 10 (i.e., the transient coupling circuit 50 can hasten the compensation of the output voltage V_{OUT} by the amplifier circuit 40). In some exemplary embodiments, because the transient coupling circuit 50 may be a circuit with simple construction, the design cost, manufacture cost, and power consumption of the voltage regulation integrated circuit 10 can be reduced.

Please refer to FIG. 1 and FIG. 3. FIG. 3 illustrates an impedance frequency response diagram of a first capacitor C1 of the transient coupling circuit 50 according to the first exemplary embodiments of the instant disclosure. In some exemplary embodiments, as shown in FIG. 1, the transient coupling circuit 50 comprises a first capacitor C1. The first capacitor C1 is electrically connected between the amplifier circuit 40 and the first output point M1_{S} of the first transistor M1. The first capacitor C1 is configured to extract the AC component of the output voltage V_{OUT} so as to generate the coupling voltage M_{BP}. In these embodiments, a value of the AC component extracted by the first capacitor C1 is determined by an impedance of the first capacitor C1. For example, the value of the AC component extracted by the first capacitor C1 may be an amplitude of the AC component. As shown in FIG. 3, the impedance of the first capacitor C1 changes in response to the frequency, and the smaller the impedance of the first capacitor C1, the easier to extract the AC component of the output voltage V_{OUT}. As a result, the higher the frequency of the AC component of the transient change of the output voltage V_{OUT}, the easier for the first capacitor C1 to extract the AC component of the output voltage V_{OUT} as the coupling voltage M_{BP}, and the output voltage V_{OUT} can be corrected back to the target voltage level according to the previously described mechanism.

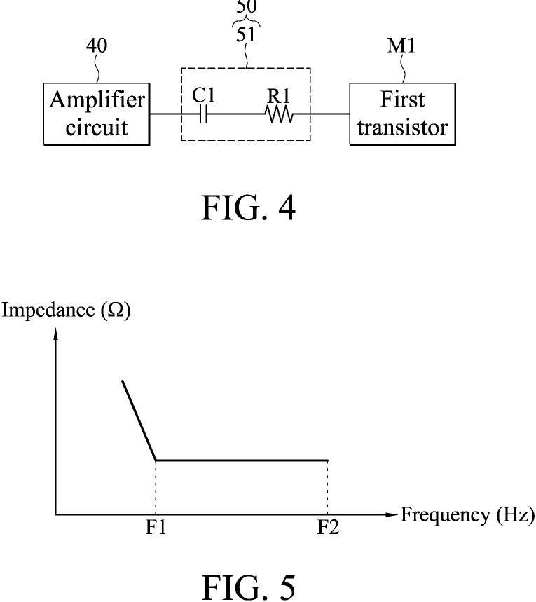

Please refer to FIG. 4 and FIG. 5. FIG. 4 illustrates a schematic diagram of the transient coupling circuit 50 according to some exemplary embodiments of the instant disclosure. FIG. 5 illustrates an impedance frequency response diagram of a series circuit 51 of the transient coupling circuit 50 according to the second exemplary embodiments of the instant disclosure. In some exemplary embodiments, as shown in FIG. 4, the transient coupling circuit 50 comprises a first capacitor C1 and a first resistor R1. The first capacitor C1 and the first resistor R1 are connected in series to form a series circuit 51. The series circuit 51 is electrically connected between the amplifier circuit 40 and the first output end M1_{S} of the first transistor M1. The series circuit 51 is configured to extract the AC component of the output voltage V_{OUT} so as to generate the coupling voltage M_{BP}. In these embodiments, the value of the AC component extracted by the series circuit 51 is determined by the impedance of the series circuit 51. For example, the value of the AC component extracted by the series circuit 51 may be an amplitude of the AC component. As shown in FIG. 5, similar to the first exemplary embodiment, in the second embodiment, an impedance of the series circuit 51 changes in response to the frequency. The difference between the first exemplary embodiment and the second exemplary embodiment is that, in the second embodiment, the ability of the transient coupling circuit 50 to extract the AC component within a frequency band between a frequency point F1 and a frequency point F2 is almost identical.

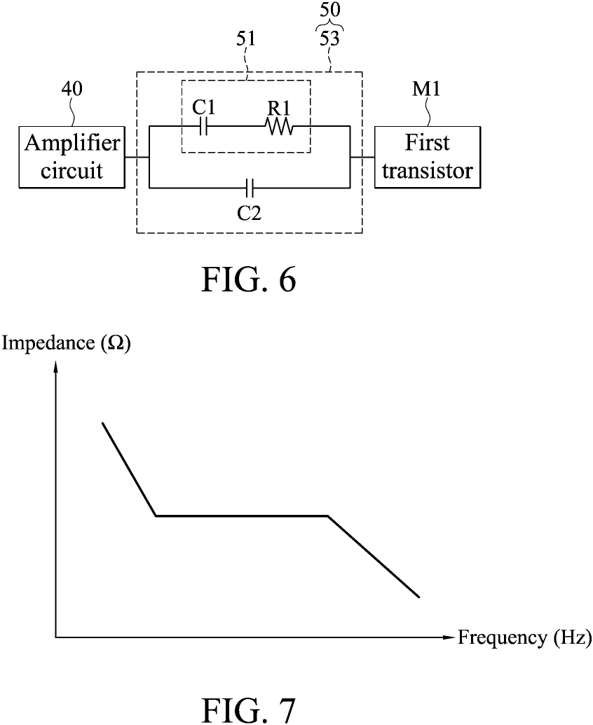

Please refer to FIG. 6 and FIG. 7. FIG. 6 illustrates a schematic diagram of the transient coupling circuit 50 according to some exemplary embodiments of the instant disclosure. FIG. 7 illustrates an impedance frequency response diagram of a series-shunt circuit 53 of the transient coupling circuit 50 according to the third exemplary embodiments of the instant disclosure. In some exemplary embodiments, as shown in FIG. 6, the transient coupling circuit 50 comprises a first capacitor C1, a first resistor R1, and a second capacitor C2. The first capacitor C1 and the first resistor R1 are connected in series (i.e., form a series circuit 51), and the second capacitor C2 is shunted with the series circuit 51 to form a series-shunt circuit 53. The series-shunt circuit 53 is electrically connected between the amplifier circuit 40 and the first output end M1_{S} of the first transistor M1. The series-shunt circuit 53 is configured to extract the AC component of the output voltage V_{OUT} so as to generate the coupling voltage M_{BP}. In these embodiments, the value of the AC component extracted by the series-shunt circuit 53 is determined by an impedance of the series-shunt circuit 53. For example, the value of the AC component extracted by the series-shunt circuit 53 may be an amplitude of the AC component. As shown in FIG. 7, similar to the first exemplary embodiment and the second exemplary embodiment, in the third embodiment, the impedance of the series-shunt circuit 53 changes in response to the frequency. As a result, the series-shunt circuit 53 can extract AC components of the output voltage V_{OUT} with different values at different frequencies so as to correct the output voltage V_{OUT} quickly.

As shown in FIG. 1, in some exemplary embodiments, the voltage regulation integrated circuit 10 further comprises a cut-off impedance R_{B1} between a first node N1 and a second node N2. The cut-off impedance R_{B1} is configured to cut off the AC transmission between the first node N1 and the second node N2. The bias circuit 30 generates the first bias voltage V_{BP1} at the first node N1. The amplifier circuit 40 receives the first bias voltage V_{BP1} from the second node N2. The transient coupling circuit 50 assists the change of the voltage at the second node N2 (i.e., the transient coupling circuit 50 assists the change of the first bias voltage V_{BP1} at the second node N2). Therefore, in this embodiment, the coupling voltage M_{BP} does not affect the first bias voltage V_{BP1} at the first node N1. In other words, in this embodiment, the coupling voltage M_{BP} does not affect the operation of the bias circuit 30.

In some exemplary embodiments, the effect of the output voltage V_{OUT} being quickly maintained at a voltage level can be achieved by the transient coupling circuit 50 not only through the change of the voltage at the second node N2 according to the coupling voltage M_{BP} but also through the change of the voltages at the nodes other than the second node N2 in the amplifier circuit 40. For example, the transient coupling circuit 50 assists the change of the voltage at a node other than the second node N2 in the amplifier circuit 40 according to the coupling voltage M_{BP}, and when said voltage at said node is changed, the output voltage V_{OUT} can be corrected in the direction opposite to the direction in which the output voltage V_{OUT} deviated.

As shown in FIG. 1, in some exemplary embodiments, the amplifier circuit 40 comprises an input circuit 41 and a gain circuit 43. The input circuit 41 is electrically connected to the feedback circuit 20 and the bias circuit 30. The gain circuit 43 is electrically connected to the input circuit 41, the bias circuit 30, the transient coupling circuit 50, and the first control end M1_{G} of the first transistor M1. The input circuit 41 is configured to generate a pre-voltage V_{PV} according to the feedback voltage V_{FB} and a reference voltage V_{REF}. The gain circuit 43 is configured to generate the control voltage V_{G1} according to the pre-voltage V_{PV} and the first bias voltage V_{BP1}. The reference voltage V_{REF} may be a voltage generated by a bandgap reference voltage generation circuit (not shown in the figure). In some exemplary embodiments, the amplifier circuit 40 may be implemented using a single-stage amplifier or a multi-stage amplifier (such as a two-stage amplifier).

In some exemplary embodiments, compared with the input circuit 41, the gain circuit 43 can more directly affect the change of the control voltage V_{G1}. As a result, compared with the transient circuit 50 assisting the change of the voltages at the nodes in the input circuit 41, the effect of the output voltage V_{OUT} being more quickly maintained at a voltage level can be better achieved by the transient circuit 50 through assisting the change of the voltages at the nodes in the gain circuit 43 (such as the first bias voltage V_{BP1} at the second node N2).

As shown in FIG. 1, in some exemplary embodiments, the gain circuit 43 comprises a current source circuit (described as a second current source circuit I₂ hereinafter) and a gain sub circuit 431. The second current source circuit I₂ is configured to generate a bias current (described as a fourth bias current I_{B4} hereinafter) according to the first bias voltage V_{BP1}. The fourth bias current I_{B4} may be a steady current. The gain sub circuit 431 is configured to generate the control voltage V_{G1} according to the pre-voltage V_{PV} and the fourth bias current I_{B4}. For example, the gain sub circuit 431 is enabled based on the fourth bias current I_{B4} and boosts the pre-voltage V_{PV} so as to generate the control voltage V_{G1}.

As an example, the amplifier circuit 40 is a two-stage amplifier, wherein the input circuit 41 is a first-stage gain circuit and provides a first gain, and the gain circuit 43 is a second-stage gain circuit and provides a second gain. A total gain of the amplifier circuit 40 is the first gain times the second gain.

As shown in FIG. 1, in some exemplary embodiments, the input circuit 41 comprises a differential transistor pair 411 and a current mirror circuit (described as a first current mirror circuit 413 hereinafter). The differential transistor pair 411 is configured to generate a feedback current I_{FB} according to the feedback voltage V_{FB}. The first current mirror circuit 413 is configured to generate a mirrored current I_{MR} according to the feedback current I_{FB}. The differential transistor pair 411 generates the pre-voltage V_{PV} according to the reference voltage V_{REF} and the mirrored current I_{MR}. In these embodiments, a first ratio exists between the mirrored current I_{MR} and the feedback current I_{FB}. For example, the first ratio is proportional to the mirrored current I_{MR}, and the first ratio is inversely proportional to the feedback current I_{FB}, but the instant disclosure is not limited thereto. In one or some exemplary embodiments, the first ratio may be constant or configurable. For example, the first current mirror circuit 413 may be a configurable current mirror so that the first ratio is thus configurable. In some exemplary embodiments, the pre-voltage V_{PV} is a single-ended voltage.

For example, as shown in FIG. 1, the differential transistor pair 411 comprises a second transistor M2 and a third transistor M3. As an example, the second transistor M2 and the third transistor M3 are P-channel transistors. The second transistor M2 comprises a second output end M2_{D} and a second control end M2_{G}. The third transistor M3 comprises a third output end M3_{D} and a third control end M3_{G}. In this embodiment, the second output end M2_{D} and the second control end M2_{G} may be the drain and the gate of the second transistor M2, respectively, and the third output end M3_{D} and the third control end M3_{G} may be the drain and the gate of the third transistor M3, respectively. The second output end M2_{D} is electrically connected to the first current mirror circuit 413. The second control end M2_{G} is configured to receive the feedback voltage V_{FB}. The second transistor M2 is configured to generate the feedback current I_{FB} at the second output end M2_{D} according to the feedback voltage V_{FB}. The third output end M3_{D} is electrically connected to the first current mirror circuit 413 and the gain circuit 43. The third control end M3_{G} is configured to receive the reference voltage V_{REF}. The third transistor M3 is configured to generate the pre-voltage V_{PV} at the third output end M3_{D} according to the reference voltage V_{REF} and the mirrored current I_{MR}.

In some exemplary embodiments, the input circuit 41 further comprises a level shifter (not shown in the figure). The level shifter is electrically connected between the differential transistor pair 411 and the first current mirror circuit 413. The level shifter is configured to adjust the DC component of the feedback voltage V_{FB} and the DC component of the reference voltage V_{REF} so as to optimize the DC operation of the input circuit 41.

As shown in FIG. 1, in some exemplary embodiments, the input circuit 41 further comprises a first current source circuit (described as the first current source circuit I₁ hereinafter). The bias circuit 30 further generates a second bias voltage V_{BP2} for the operation of the first current source circuit I₁. The first current source circuit I₁ is configured to generate two bias currents (described as a first bias current I_{B1} and a second bias current I_{B2} hereinafter) according to the second bias voltage V_{BP2}. In some exemplary embodiments, the first bias current I_{B1} and the second bias current I_{B2} may be two sub currents obtained by splitting a main bias current (such as the third bias current I_{B3} shown in FIG. 1). In some exemplary embodiments, the first current source circuit I₁ may be implemented using a transistor (such as the fourth transistor M4 shown in FIG. 1). The first bias current I_{B1} and the second bias current I_{B2} may be two steady currents. The first bias current I_{B1} travels through the second transistor M2. The second bias current I_{B2} travels through the third transistor M3. The second transistor M2 generates the feedback current I_{FB} at the second output point M2_{D} according to the feedback voltage V_{FB} and the first bias current I_{B1}. The third transistor M3 generates the pre-voltage V_{PV} at the third output point M3_{D} according to the reference voltage V_{REF}, the mirrored current I_{MR}, and the second bias current I_{B2}. For example, the third transistor M3 subtracts the mirrored current I_{MR} from the second bias current I_{B2} and then generates the pre-voltage V_{PV} according to the reference voltage V_{REF} and the result of the aforementioned subtraction. As a result, the input circuit 41 can provide the first gain. For example, the input circuit 41 amplifies the difference between the reference voltage V_{REF} and the feedback voltage V_{FB} using the first gain so as to generate the pre-voltage V_{PV}.

As shown in FIG. 1, in some exemplary embodiments, the second current source circuit I₂ comprises a sixth transistor M6. The sixth transistor M6 comprises a sixth control end M6_{G} and a sixth output end M6_{D}. In these embodiments, the sixth control end M6_{G} and the sixth output end M6_{D} may be the gate and drain of the sixth transistor M6, respectively. As an example, the sixth transistor M6 is a P-channel transistor. The sixth output end M6_{D} is electrically connected to the gain sub circuit 431 and the first transistor M1. The sixth control end M6_{G} is electrically connected to the second node N2 so as to receive the first bias voltage V_{BP1}. The sixth transistor M6 is configured to generate the fourth bias current I_{B4} at the sixth output end M6_{D} according to the first bias voltage V_{BP1}. The sixth output point M6_{D} is configured to transmit the fourth bias current I_{B4} to the gain sub circuit 431.

As shown in FIG. 1, in some exemplary embodiments, the gain sub circuit 431 comprises a seventh transistor M7 and a third capacitor C3. The seventh transistor M7 comprises a seventh control end M7_{G} and a seventh output end M7_{D}. As an example, the seventh transistor M7 is an N-channel transistor. The seventh control end M7_{G} and the seventh output end M7_{D} may be the gate and the drain of the seventh transistor M7, respectively. The seventh control end M7_{G} is configured to receive the pre-voltage V_{PV}. The seventh output end M7_{D} is electrically connected to the sixth output end M6_{D} and the first transistor M1. The seventh transistor M7 is configured to generate the control voltage V_{G1} at the seventh output end M7_{D} according to the pre-voltage V_{PV} and the fourth bias current I_{B4}. The third capacitor C3 is between the seventh control end M7_{G} and the seventh output point M7_{D}. The third capacitor C3 is configured to perform Miller compensation on the control voltage V_{G1} so as to decrease the effect resulting from poles other than a dominant pole on the control voltage V_{G1}. In some exemplary embodiments, the third capacitor C3 can be further connected to a second resistor R2 in series so as to increase the stability by compensating the zero produced by the third capacitor C3. ). In some exemplary embodiments, the seventh transistor M7 is implemented using a common-source transistor, and the seventh transistor M7 provides a second gain. For example, the seventh transistor M7 boosts the pre-voltage using the second gain according to the fourth bias current I_{B4} and then generates the control voltage V_{G1} at the seventh output end M7_{D}.

As an example, the amplifier circuit 40 is a single-stage amplifier, wherein the gain circuit 43 provides all gains or main gain(s) of the amplifier circuit 40.

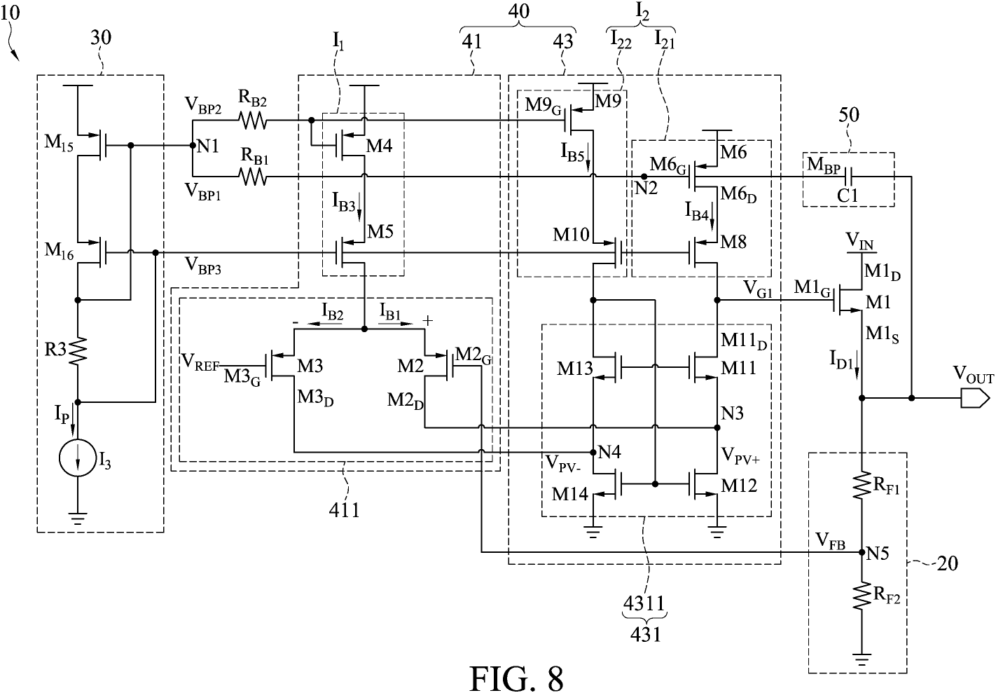

FIG. 8 illustrates a block diagram of the voltage regulation integrated circuit 10 according to some exemplary embodiments of the instant disclosure. Please refer to FIG. 8. In some exemplary embodiments, the pre-voltage V_{PV} is a differential voltage. For example, the pre-voltage V_{PV} comprises a first pre-voltage V_{PV+} and a second pre-voltage V_{PV-}. The input circuit 41 comprises a differential transistor pair 411. The differential transistor pair 411 comprises a second transistor M2 and a third transistor M3. The second transistor M2 is configured to generate the first pre-voltage V_{PV+} according to the feedback voltage V_{FB} and the first bias current I_{B1}. The third transistor M3 is configured to generate the second pre-voltage V_{PV-} according to the reference voltage V_{REF} and the second bias current I_{B2}.

As shown in FIG. 8, in some exemplary embodiments, the bias circuit 30 generates a second bias voltage V_{BP2} and a third bias voltage V_{BP3}. The input circuit 41 comprises a first current source circuit I₁. The first current source circuit I₁ is configured to generate the first bias current I_{B1} and the second bias current I_{B2} according to the second bias voltage V_{BP2} and the third bias voltage V_{BP3}.

In some exemplary embodiments, the first current source circuit I₁ generates and transmits a third bias current I_{B3} according to the second bias voltage V_{BP2} and the third bias voltage V_{BP3}, and the first bias current I_{B1} and the second bias current I_{B2} are split currents of the third bias current I_{B3}. In these embodiments, the third bias current I_{B3} is a steady current. For example, as shown in FIG. 8, the first current source circuit I₁ comprises a fourth transistor M4 and a fifth transistor M5. The fifth transistor M5 is cascoded with the fourth transistor M4. The fourth transistor M4 is configured to generate a third bias current I_{B3} according to the second bias voltage V_{BP2}. The fifth transistor M5 is turned on according to the third bias voltage V_{BP3} to split the third bias current I_{B3} into the first bias current I_{B1} and the second bias current I_{B2}, transmit the first bias current I_{B1} to the second transistor M2, and transmit the second bias current I_{B2} to the third transistor M3.

As shown in FIG. 8, in some exemplary embodiments, the second current source circuit I₂ comprises a first current source sub circuit I₂₁ and a second current source sub circuit I₂₂. The gain sub circuit 431 comprises a second current mirror circuit 4311. The first current source sub circuit I₂₁ and the second current source sub circuit I₂₂ are electrically connected to the second current mirror circuit 4311 and the bias circuit 30. The first current source sub circuit I₂₁ is configured to generate a fourth bias current I_{B4} according to the first bias voltage V_{BP1}. The second current source sub circuit I₂₂ is configured to generate a fifth bias current I_{B5} according to the second bias voltage V_{BP2}. The second current mirror circuit 4311 is configured to generate the control voltage V_{G1} according to the pre-voltage V_{PV}, the fourth bias current I_{B4}, and the fifth bias current I_{B5}. Alternatively, in one or some embodiments, the second current mirror circuit 4311 is configured to generate the control voltage V_{G1} according to the first pre-voltage V_{PV+}, the second pre-voltage V_{PV-}, the fourth bias current I_{B4}, and the fifth bias current I_{B5}.

For example, as shown in FIG. 8, the first current source sub circuit I₂₁ comprises a sixth transistor M6 and an eighth transistor M8. The eighth transistor M8 is cascoded with the sixth transistor M6. The second current source sub circuit I₂₂ comprises a ninth transistor M9 and a tenth transistor M10. The tenth transistor M10 is cascoded with the ninth transistor M9. The sixth transistor M6 comprises a sixth control end M6_{G}. The sixth control end M6_{G} is configured to receive the first bias voltage V_{BP1}. The ninth transistor M9 comprises a ninth control end M9_{G}. The ninth control end M9_{G} is configured to receive the second bias voltage V_{BP2}. The sixth control end M6_{G} and the ninth control end M9_{G} may be the gate of the sixth transistor M6 and the gate of the ninth transistor M9, respectively. The sixth transistor M6 generates the fourth bias current I_{B4} according to the first bias voltage V_{BP1}. The eighth transistor M8 transmits the fourth bias current I_{B4} to the second current mirror circuit 4311. The ninth transistor M9 generates the fifth bias current I_{B5} according to the second bias voltage V_{BP2}. The tenth transistor M10 transmits the fifth bias current I_{B5} to the second current mirror circuit 4311. In some exemplary embodiments, the sixth transistor M6 and the eighth transistor M8 form a wide-swing cascode circuit so as to provide the fourth bias current I_{B4} in a steady manner. The ninth transistor M9 and the tenth transistor M10 form a wide-swing cascode circuit so as to provide the fifth bias current I_{B5} in a steady manner.

The second current mirror circuit 4311 comprises an eleventh transistor M11, a twelfth transistor M12, a thirteen transistor M13, a fourteenth transistor M14, a third node N3, and a fourth node N4. The third node N3 is between the eleventh transistor M11 and the twelfth transistor M12. The fourth node N4 is between the thirteenth transistor M13 and the fourteenth transistor M14. The third node N3 is configured to receive the first pre-voltage V_{PV+}, and the fourth node N4 is configured to receive the second pre-voltage V_{PV-} The twelfth transistor M12 is cascoded with the eleventh transistor M11. The fourth bias current I_{B4} travels through the eleventh transistor M11 and the twelfth transistor M12 which are cascaded with each other. The fourteenth transistor M14 is cascoded with the thirteenth transistor. The fifth bias current I_{B5} travels through the thirteenth transistor M13 and the fourteenth transistor M14 which are cascoded with each other. The eleventh transistor M11 comprises an eleventh output end M11_{D}. Through current changes of the eleventh transistor M11, the twelfth transistor M12, the thirteenth transistor M13, and the fourteenth transistor M14, the difference between the first pre-voltage V_{PV+} and the second pre-voltage V_{PV-} can be amplified at the eleventh output end M11_{D}, thus generating the control voltage V_{G1}. Therefore, in this embodiment, the sixth transistor M6, the eighth transistor M8, the ninth transistor M9, the tenth transistor M10, the eleventh transistor M11, the twelfth transistor M12, the thirteenth transistor M13, and the fourteenth transistor M14 can jointly provide a gain as the whole gain or the main gain(s) of the amplifier circuit 40. For example, the first current source sub circuit I₂₁ and the second current mirror circuit 4311 amplify the first pre-voltage V_{PV+} and the second pre-voltage V_{PV-} using the gain to generate the control voltage V_{G1}. Alternatively, in some embodiments, the first current source sub circuit I₂₁ and the second current mirror circuit 4311 amplify the difference between the first pre-voltage V_{PV+} and the second pre-voltage V_{PV-} using the gain to generate the control voltage V_{G1}.

In some exemplary embodiments, a second ratio exists between the fourth bias current I_{B4} and the fifth bias current I_{B5}.For example, the second ratio is proportional to the fourth bias current I_{B4} and inversely proportional to the fifth bias current I_{B5}, but the instant disclosure is not limited thereto. Alternatively, in some embodiments, the second ratio may be inversely proportional to the fourth bias current I_{B4} and proportional to the fifth bias current I_{B5}.The second ratio may be constant or configurable. For example, the second current mirror circuit 4311 may be a configurable current mirror so that the second ratio is thus configurable.

As shown in FIG. 1, in some exemplary embodiments, the feedback circuit 20 comprises a first divider impedance R_{F1}, a second divider impedance R_{F2}, and a fifth node N5. The first divider impedance R_{F1} is electrically connected to the first output end M1_{S}. The second divider impedance R_{F2} is electrically connected to the first divider impedance R_{F1}. The fifth node N5 is between the first divider impedance R_{F1} and the second divider impedance R_{F2}. The first divider impedance R_{F1} and the second divider impedance R_{F2} generate the feedback voltage V_{FB} at the fifth node N5 according to the output voltage V_{OUT}. Specifically, in these embodiments, the first divider impedance R_{F1} and the second divider impedance R_{F2} divide the output voltage V_{OUT} to generate the feedback voltage V_{FB} at the fifth node N5. As a result, a value of a voltage fed back to the amplifier circuit 40 can be decreased so as to conform to an input specification of the amplifier circuit 40, and the feedback voltage V_{FB} changes in response to the change of the output voltage V_{OUT}. In some exemplary embodiments, the first divider impedance R_{F1} and the second divider impedance R_{F2} may be implemented using passive elements such as resistors, capacitors, or inductors. Preferably, in some embodiments, the first divider impedance R_{F1} and the second divider impedance R_{F2} are implemented using resistors, and the first divider impedance R_{F1} and the second divider impedance R_{F2} may have identical or different resistances.

As shown in FIG. 1, in some exemplary embodiments, the bias circuit 30 comprises a third current source circuit I₃ and a fifteenth transistor M15. The third current source circuit I₃ is electrically connected to the fifteenth transistor M15. The third current source circuit I₃ is configured to output a pre-set current I_{P}. The fifteenth transistor M15 is configured to generate the first bias voltage V_{BP1} according to the pre-set current I_{P}. In some exemplary embodiments, the third current source circuit I₃ may be implemented using transistors. Preferably, in some embodiments, current values of the transistors used to implement the current source circuit I₃ may be determined according to a standard current generated by a bandgap reference circuit. In some exemplary embodiments, as shown in FIG. 1, the fifteenth transistor M15 can generate not only the first bias voltage V_{BP1} but also the second bias voltage V_{BP2}, and the first bias voltage V_{BP1} and the second bias voltageV_{BP2} have identical voltage values. As a result, through the pre-set current I_{P} which is steady, the bias circuit 30 can generate the first bias voltage V_{BP1} and the second bias voltage V_{BP2} in a steady manner. In some exemplary embodiments, as shown in FIG. 1, the first bias voltage V_{BP1} of the bias circuit 30 is outputted to the gain circuit 43, the second bias voltage V_{BP2} of the bias circuit 30 is outputted to the input circuit 41, the cut-off impedance R_{B1} exists between the bias circuit 30 and the gain circuit 43, and an cut-off impedance R_{B2} exists between the bias circuit 30 and the input circuit 41. The cut-off impedance R_{B1} can cut off the AC transmission between the gain circuit 43 and the bias circuit 30, and the cut-off impedance R_{B2} can cut off the AC transmission between the input circuit 41 and the bias circuit 30. As a result, the bias circuit 30 can avoid being affected by the AC signals of the amplifier circuit 40 (i.e., the input circuit 41 and the gain circuit 43).

In some exemplary embodiments, as shown in FIG. 8, the bias circuit 30 further comprises a sixteenth transistor M16 and a third resistor R3. The sixteenth transistor M16 is connected to the third resistor R3 in series to form a series circuit, and the series circuit formed by the sixteenth transistor M16 and the third resistor R3 is electrically connected between the third current source circuit I₃ and the fifteenth transistor M15. The third resistor R3 can provide a better gate bias voltage for the sixteenth transistor M16. The sixteenth transistor M16 is configured to generate the third bias voltage V_{BP3} according to the pre-set current I_{P}. Through the pre-set current I_{P}, which is steady, the bias circuit 30 can generate the third bias voltage V_{BP3} in a steady manner. In some exemplary embodiments, the first bias voltage V_{BP1} and the second bias voltage V_{BP2} have identical voltage values, and a voltage value of the third bias voltage V_{BP3} is different from the voltage value of the first bias voltage V_{BP1} or the voltage value of the second bias voltage VBP2.

It is worth noting that the transistors in this disclosure may be implemented using N- or P-channel transistors. When using transistors of different types from those of the transistors used in the abovementioned exemplary embodiments to implement the transistors, one can derive how to properly adjust the construction of the voltage regulation integrated circuit 10 according to this disclosure.

In summary, according to some exemplary embodiments, through the transient coupling circuit, the effect of the transient response of the feedback circuit can be hastened, so that the output voltage can be quickly corrected back to the target output voltage level when the load changes quickly. According to some exemplary embodiments, because the transient coupling circuit may be constructed using simple passive elements, the output voltage can be quickly corrected back to the target output voltage level without increased circuit power consumption when the load quickly changes.

What is claimed is:

1. A voltage regulation integrated circuit (IC) comprising:
a first transistor configured to generate an output voltage according to an input voltage and a control voltage;
a feedback circuit configured to generate a feedback voltage according to the output voltage, wherein the output voltage comprises an AC component;
a bias circuit configured to generate a first bias voltage;
an amplifier circuit configured to generate the control voltage according to the first bias voltage and the feedback voltage; and
a transient coupling circuit configured to generate a coupling voltage according to the AC component and to assist the change of the first bias voltage according to the coupling voltage, so that the output voltage is maintained at a voltage level.

2. The voltage regulation integrated circuit according to claim 1, wherein the transient coupling circuit comprises a first capacitor configured to extract the AC component so as to generate the coupling voltage; wherein the value of the AC component extracted by the first capacitor is determined by an impedance of the first capacitor.

3. The voltage regulation integrated circuit according to claim 1, wherein the transient coupling circuit comprises a first capacitor and a first resistor, the first capacitor and the first resistor are connected in series to form a series circuit, and the series circuit is configured to extract the AC component so as to generate the coupling voltage;
wherein the value of the AC component extracted by the series circuit is determined by an impedance of the series circuit.

4. The voltage regulation integrated circuit according to claim 1, wherein the transient coupling circuit comprises a first capacitor, a first resistor, and a second capacitor, the first capacitor and the first resistor are connected in series to form a series circuit and the second capacitor is shunted with the series circuit to form a series-shunt circuit, and the series-shunt circuit is configured to extract the AC component so as to generate the coupling voltage; wherein the value of the AC component extracted by the series-shunt circuit is determined by an impedance of the series-shunt circuit.

5. The voltage regulation integrated circuit according to claim 1 further comprising a cut-off impedance between a first node and a second node, wherein the bias circuit generates the first bias voltage at the first node, the amplifier circuit receives the first bias voltage from the second node, and the transient coupling circuit assists the change of the voltage at the second node.

6. The voltage regulation integrated circuit according to claim 1, wherein the amplifier circuit comprises:
an input circuit configured to generate a pre-voltage according to the feedback voltage and a reference voltage; and
a gain circuit configured to generate the control voltage according to the pre-voltage and the first bias voltage.

7. The voltage regulation integrated circuit according to claim 6, wherein the input circuit comprises:
a differential transistor pair configured to generate a feedback current according to the feedback voltage; and
a first current mirror circuit configured to generate a mirrored current according to the feedback current, wherein the differential transistor pair generates the pre-voltage according to the reference voltage and the mirrored current.

8. The voltage regulation integrated circuit according to claim 7, wherein the differential transistor pair comprises:
a second transistor comprising:
a second output end electrically connected to the first current mirror circuit; and
a second control end configured to receive the feedback voltage, wherein the second transistor is configured to generate the feedback current at the second output end according to the feedback voltage; and a third transistor comprising:
a third output end electrically connected to the first current mirror circuit and the gain circuit; and
a third control end configured to receive the reference voltage, wherein the third transistor is configured to generate the pre-voltage at the third output end according to the reference voltage and the mirrored current.

9. The voltage regulation integrated circuit according to claim 8, wherein the bias circuit further generates a second bias voltage, and the input circuit further comprises a first current source circuit configured to generate a first bias current and a second bias current according to the second bias voltage; wherein the second transistor generates the feedback current at the second output end according to the feedback voltage and the first bias current, and the third transistor generates the pre-voltage at the third output end according to the reference voltage, the mirrored current, and the second bias current.

10. The voltage regulation integrated circuit according to claim 6, wherein the pre-voltage comprises a first pre-voltage and a second pre-voltage, and the input circuit comprises:
a differential transistor pair comprising:
a second transistor configured to generate the first pre-voltage according to the feedback voltage and a first bias current; and
a third transistor configured to generate the second pre-voltage according to the reference voltage and a second bias current.

11. The voltage regulation integrated circuit according to claim 10, wherein the bias circuit further generates a second bias voltage and a third bias voltage, and the input circuit further comprises a first current source circuit configured to generate a first bias current and a second bias current according to the second bias voltage and the third bias voltage.

12. The voltage regulation integrated circuit according to claim 11, wherein the first current source circuit comprises:
a fourth transistor configured to generate a third bias current according to the second bias voltage; and
a fifth transistor cascoded with the fourth transistor and configured to be turned on according to the third bias voltage, split the third bias current into the first bias current and the second bias current, transmit the first bias current to the second transistor, and transmit the second bias current to the third transistor.

13. The voltage regulation integrated circuit according to claim 6, wherein the gain circuit comprises:
a second current source circuit configured to generate a fourth bias current according to the first bias voltage; and
a gain sub circuit configured to generate the control voltage according to the pre-voltage and the fourth bias current.

14. The voltage regulation integrated circuit according to claim 13, wherein the second current source circuit comprises a sixth transistor, and the sixth transistor comprises:
a sixth control end configured to receive the first bias voltage, wherein the sixth transistor is configured to generate the fourth bias current according to the first bias voltage; and
a sixth output end electrically connected to the gain sub circuit and the first transistor so as to transmit the fourth bias current to the gain sub circuit.

15. The voltage regulation integrated circuit according to claim 14, wherein the gain sub circuit comprises:
a seventh transistor comprising:
a seventh control end configured to receive the pre-voltage; and
a seventh output end electrically connected to the sixth output end and the first transistor, wherein the seventh transistor is configured to generate the control voltage at the seventh output end according to the pre-voltage and the fourth bias current.

16. The voltage regulation integrated circuit according to claim 13, wherein the bias circuit further generates a second bias voltage;
wherein the second current source circuit comprises:
a first current source sub circuit configured to generate the fourth bias current according to the first bias voltage; and
a second current source sub circuit configured to generate a fifth bias current according to the second bias voltage;
wherein the gain sub circuit comprises:
a second current mirror circuit configured to generate the control voltage according to the pre-voltage, the fourth bias current, and the fifth bias current.

17. The voltage regulation integrated circuit according to claim 16, wherein the first current source sub circuit comprises:
a sixth transistor comprising a sixth control end, wherein the sixth control end is configured to receive the first bias voltage, and the sixth transistor generates the fourth bias current according to the first bias voltage; and
an eighth transistor cascoded with the sixth transistor and transmitting the fourth bias current to the second current mirror circuit;
wherein the second current source circuit comprises:
a ninth transistor comprising a ninth control end, wherein the ninth control end is configured to receive the second bias voltage, and the ninth transistor generates the fifth bias current according to the second bias voltage; and
a tenth transistor cascoded with the ninth transistor and transmitting the fifth bias current to the second current mirror circuit.

18. The voltage regulation integrated circuit according to claim 17, wherein the pre-voltage comprises a first pre-voltage and a second pre-voltage, and the second current mirror circuit comprises:
an eleventh transistor comprising an eleventh output end, wherein the eleventh output end is configured to transmit the control voltage to the first transistor;
a twelfth transistor cascoded with the eleventh transistor, wherein the fourth bias current travels through the eleventh transistor and the twelfth transistor cascoded with each other;
a thirteenth transistor;
a fourteenth transistor cascoded with the thirteenth transistor, wherein the fifth bias current travels through the thirteenth transistor and the fourteenth transistor cascoded with each other;
a third node between the eleventh transistor and the twelfth transistor; and
a fourth node between the thirteenth transistor and the fourteenth transistor, wherein the third node is configured to receive the first pre-voltage, and the fourth node is configured to receive the second pre-voltage.

19. The voltage regulation integrated circuit according to claim 1, wherein the feedback circuit comprises a first divider impedance, a second divider impedance, and a fifth node, the fifth node is between the first divider impedance and the second divider impedance, and the first divider impedance and the second divider impedance generate the feedback voltage at the fifth node according to the output voltage.

20. The voltage regulation integrated circuit according to claim 1, wherein the bias circuit comprises:
a third current source circuit configured to output a pre-set current; and
a fifteenth transistor configured to generate the first bias voltage according to the pre-set current.
